(19) United States
(12) Patent Application Publication
(10) Pub. No.: US 2019/0325262 A1
(43) Pub. Date: Oct. 24, 2019

(54) MANAGING DERIVED AND MULTI-ENTITY FEATURES ACROSS ENVIRONMENTS

(71) Applicant: Microsoft Technology Licensing, LLC, Redmond, WA (US)

(72) Inventors: David J. Stein, Mountain View, CA (US); Paul T. Ogilvie, Palo Alto, CA (US); Bee-Chung Chen, San Jose, CA (US); Ke Wu, Sunnyvale, CA (US); Grace W. Tang, Los Altos, CA (US); Priyanka Gariba, San Mateo, CA (US); Yangchun Luo, Sunnyvale, CA (US); Boyi Chen, Santa Clara, CA (US); Jian Qiao, San Mateo, CA (US); Benjamin Hoan Le, San Jose, CA (US); Joel D. Young, Milpitas, CA (US); Wei Zhuang, Palo Alto, CA (US)

(73) Assignee: Microsoft Technology Licensing, LLC, Redmond, WA (US)

(21) Appl. No.: 15/958,990

(22) Filed: Apr. 20, 2018

(51) Int. Cl. G06K 9/62; G06Q 10/06; G06F 15/18

(52) U.S. Cl. CPC G06K 9/6228; G06K 9/6256; G06F 15/18; G06K 9/6224; G06Q 10/0637

(57) ABSTRACT

The disclosed embodiments provide a system for processing data. During operation, the system obtains feature configurations for a set of features. Next, the system obtains, from the feature configurations, an anchor containing metadata for accessing a first feature in an environment and a feature derivation for generating a second feature from the first feature. The system then uses the anchor to retrieve feature values of the first feature from the environment and uses the feature derivation to generate additional feature values of the second feature from the feature values of the first feature. Finally, the system provides the additional feature values for use with one or more machine learning models.

### RELATED APPLICATIONS

The subject matter of this application is related to the subject matter in a co-pending non-provisional application entitled “Common Feature Protocol for Collaborative Machine Learning,” having Ser. No. 15/046,199, and filing date 17 Feb. 2016 (Attorney Docket No. LI-901891-US-NP).

The subject matter of this application is also related to the subject matter in a co-pending non-provisional application entitled “Framework for Managing Features Across Environments,” having serial number TO BE ASSIGNED, and filing date TO BE ASSIGNED (Attorney Docket No. LI-902216-US-NP).

### BACKGROUND

### Field

The disclosed embodiments relate to machine learning systems. More specifically, the disclosed embodiments relate to techniques for managing derived features and feature dependencies across environments.

### Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, business analytics may be used to assess past performance, guide business planning, and/or identify actions that may improve future performance.

To glean such insights, large data sets of features may be analyzed using regression models, artificial neural networks, support vector machines, decision trees, naïve Bayes classifiers, and/or other types of machine-learning models. The discovered information may then be used to guide decisions and/or perform actions related to the data. For example, the output of a machine-learning model may be used to guide marketing decisions, assess risk, detect fraud, predict behavior, and/or customize or optimize use of an application or website.

However, significant time, effort, and overhead may be spent on feature selection during creation and training of machine-learning models for analytics. For example, a data set for a machine-learning model may have thousands to millions of features, including features that are created from combinations of other features, while only a fraction of the features and/or combinations may be relevant and/or important to the machine-learning model. At the same time, training and/or execution of machine-learning models with large numbers of features typically require more memory, computational resources, and time than those of machine-learning models with smaller numbers of features. Excessively complex machine-learning models that utilize too many features may additionally be at risk for overfitting.

Additional overhead and complexity may be incurred during sharing and organizing of feature sets. For example, a set of features may be shared across projects, teams, or usage contexts by denormalizing and duplicating the features in separate feature repositories for offline and online execution environments. As a result, the duplicated features may occupy significant storage resources and require synchronization across the repositories. Each team that uses the features may further incur the overhead of manually identifying features that are relevant to the team's operation from a much larger list of features for all of the teams. The same features may further be identified and/or specified multiple times during different steps associated with creating, training, validating, and/or executing the same machine-learning model.

Consequently, creation and use of machine-learning models in analytics may be facilitated by mechanisms for improving the monitoring, management, sharing, propagation, and reuse of features among the machine-learning models.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3A shows an exemplary dependency graph for a set of features in accordance with the disclosed embodiments.

FIG. 3B shows an exemplary dependency graph for a set of features in accordance with the disclosed embodiments.

FIG. 4 shows a flowchart illustrating the processing of data in accordance with the disclosed embodiments.

FIG. 5 shows a flowchart illustrating the processing of data in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

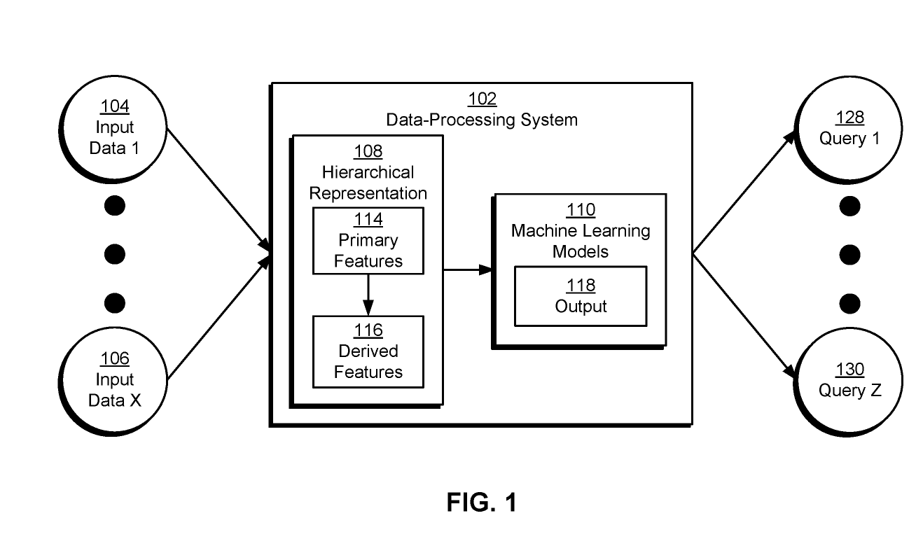

The disclosed embodiments provide a method, apparatus, and system for processing data. As shown in FIG. 1, the system includes a data-processing system 102 that analyzes one or more sets of input data (e.g., input data 1 104, input data x 106). For example, data-processing system 102 may create and train one or more machine learning models 110 for analyzing input data related to users, organizations, applications, job postings, purchases, electronic devices, websites, content, sensor measurements, and/or other categories. Machine learning models 110 may include, but are not limited to, regression models, artificial neural networks, support vector machines, decision trees, naïve Bayes classifiers, Bayesian networks, deep learning models, hierarchical models, and/or ensemble models.

In turn, the results of such analysis may be used to discover relationships, patterns, and/or trends in the data; gain insights from the input data; and/or guide decisions or actions related to the data. For example, data-processing system 102 may use machine learning models 110 to generate output 118 that includes scores, classifications, recommendations, estimates, predictions, and/or other properties. Output 118 may be inferred or extracted from primary features 114 in the input data and/or derived features 116 that are generated from primary features 114 and/or other derived features. For example, primary features 114 may include profile data, user activity, sensor data, and/or other data that is extracted directly from fields or records in the input data. The primary features 114 may be aggregated, scaled, combined, and/or otherwise transformed to produce derived features 116, which in turn may be further combined or transformed with one another and/or the primary features to generate additional derived features. After output 118 is generated from one or more sets of primary and/or derived features, output 118 is provided in responses to queries (e.g., query 1 128, query z 130) of data-processing system 102. In turn, the queried output 118 may improve revenue, interaction with the users and/or organizations, use of the applications and/or content, and/or other metrics associated with the input data.

In one or more embodiments, data-processing system 102 uses a hierarchical representation 108 of primary features 114 and derived features 116 to organize the sharing, production, and consumption of the features across different teams, execution environments, and/or projects. Hierarchical representation 108 may include a directed acyclic graph (DAG) that defines a set of namespaces for primary features 114 and derived features 116. The namespaces may disambiguate among features with similar names or definitions from different usage contexts or execution environments. Hierarchical representation 108 may include additional information that can be used to locate primary features 114 in different execution environments, calculate derived features 116 from the primary features and/or other derived features, and track the development of machine learning models 110 or applications that accept the derived features as input.

Consequently, data-processing system 102 may implement, in hierarchical representation 108, a common feature protocol that describes a feature set in a centralized and structured manner, which in turn can be used to coordinate large-scale and/or collaborative machine learning across multiple entities and machine learning models 110. Common feature protocols for large-scale collaborative machine learning are described in a co-pending non-provisional application by inventors David J. Stein, Xu Miao, Lance Wall, Joel D. Young, Eric Huang, Songxiang Gu, Da Teng, Chang-Ming Tsai and Sumit Rangwala, entitled “Common Feature Protocol for Collaborative Machine Learning,” having Ser. No. 15/046,199, and filing date 17 Feb. 2016 (Attorney Docket No. LI-901891-US-NP), which is incorporated herein by reference.

In one or more embodiments, primary features 114 and/or derived features 116 are obtained and/or used with an online professional network, social network, or other community of users that is used by a set of entities to interact with one another in a professional, social, and/or business context. The entities may include users that use the online professional network to establish and maintain professional connections, list work and community experience, endorse and/or recommend one another, search and apply for jobs, and/or perform other actions. The entities may also include companies, employers, and/or recruiters that use the online professional network to list jobs, search for potential candidates, provide business-related updates to users, advertise, and/or take other action.

As a result, features 114 and/or derived features 116 may include member features, company features, and/or job features. The member features include attributes from the members' profiles with the online professional network, such as each member's title, skills, work experience, education, seniority, industry, location, and/or profile completeness. The member features also include each member's number of connections in the online professional network, the member's tenure on the online professional network, and/or other metrics related to the member's overall interaction or “footprint” in the online professional network. The member features further include attributes that are specific to one or more features of the online professional network, such as a classification of the member as a job seeker or non-job-seeker.

The member features may also characterize the activity of the members with the online professional network. For example, the member features may include an activity level of each member, which may be binary (e.g., dormant or active) or calculated by aggregating different types of activities into an overall activity count and/or a bucketized activity score. The member features may also include attributes (e.g., activity frequency, dormancy, total number of user actions, average number of user actions, etc.) related to specific types of social or online professional network activity, such as messaging activity (e.g., sending messages within the online professional network), publishing activity (e.g., publishing posts or articles in the online professional network), mobile activity (e.g., accessing the social network through a mobile device), job search activity (e.g., job searches, page views for job listings, job applications, etc.), and/or email activity (e.g., accessing the online professional network through email or email notifications).

The company features include attributes and/or metrics associated with companies. For example, company features for a company may include demographic attributes such as a location, an industry, an age, and/or a size (e.g., small business, medium/enterprise, global/large, number of employees, etc.) of the company. The company features may further include a measure of dispersion in the company, such as a number of unique regions (e.g., metropolitan areas, counties, cities, states, countries, etc.) to which the employees and/or members of the online professional network from the company belong.

A portion of company features may relate to behavior or spending with a number of products, such as recruiting, sales, marketing, advertising, and/or educational technology solutions offered by or through the online professional network. For example, the company features may also include recruitment-based features, such as the number of recruiters, a potential spending of the company with a recruiting solution, a number of hires over a recent period (e.g., the last 12 months), and/or the same number of hires divided by the total number of employees and/or members of the online professional network in the company. In turn, the recruitment-based features may be used to characterize and/or predict the company's behavior or preferences with respect to one or more variants of a recruiting solution offered through and/or within the online professional network.

The company features may also represent a company's level of engagement with and/or presence on the online professional network. For example, the company features may include a number of employees who are members of the online professional network, a number of employees at a certain level of seniority (e.g., entry level, mid-level, manager level, senior level, etc.) who are members of the online professional network, and/or a number of employees with certain roles (e.g., engineer, manager, sales, marketing, recruiting, executive, etc.) who are members of the online professional network. The company features may also include the number of online professional network members at the company with connections to employees of the online professional network, the number of connections among employees in the company, and/or the number of followers of the company in the online professional network. The company features may further track visits to the online professional network from employees of the company, such as the number of employees at the company who have visited the online professional network over a recent period (e.g., the last 30 days) and/or the same number of visitors divided by the total number of online professional network members at the company.

One or more company features may additionally be derived features 116 that are generated from member features. For example, the company features may include measures of aggregated member activity for specific activity types (e.g., profile views, page views, jobs, searches, purchases, endorsements, messaging, content views, invitations, connections, recommendations, advertisements, etc.), member segments (e.g., groups of members that share one or more common attributes, such as members in the same location and/or industry), and companies. In turn, the company features may be used to glean company-level insights or trends from member-level online professional network data, perform statistical inference at the company and/or member segment level, and/or guide decisions related to business-to-business (B2B) marketing or sales activities.

The job features describe and/or relate to job listings and/or job recommendations within the online professional network. For example, the job features may include declared or inferred attributes of a job, such as the job's title, industry, seniority, desired skill and experience, salary range, and/or location. One or more job features may also be derived features 116 that are generated from member features and/or company features. For example, the job features may provide a context of each member's impression of a job listing or job description. The context may include a time and location (e.g., geographic location, application, website, web page, etc.) at which the job listing or description is viewed by the member. In another example, some job features may be calculated as cross products, cosine similarities, statistics, and/or other combinations, aggregations, scaling, and/or transformations of member features, company features, and/or other job features.

Those skilled in the art will appreciate that primary features 114 and/or derived features 116 may be obtained from multiple data sources, which in turn may be distributed across different environments. For example, the features may be obtained from data sources in online, offline, nearline, streaming, and/or search-based execution environments. In addition, each data source and/or environment may have a separate application-programming interface (API) for retrieving and/or transforming the corresponding features. Consequently, managing, sharing, obtaining, and/or calculating features across the environments may require significant overhead and/or customization to specific environments and/or data sources.

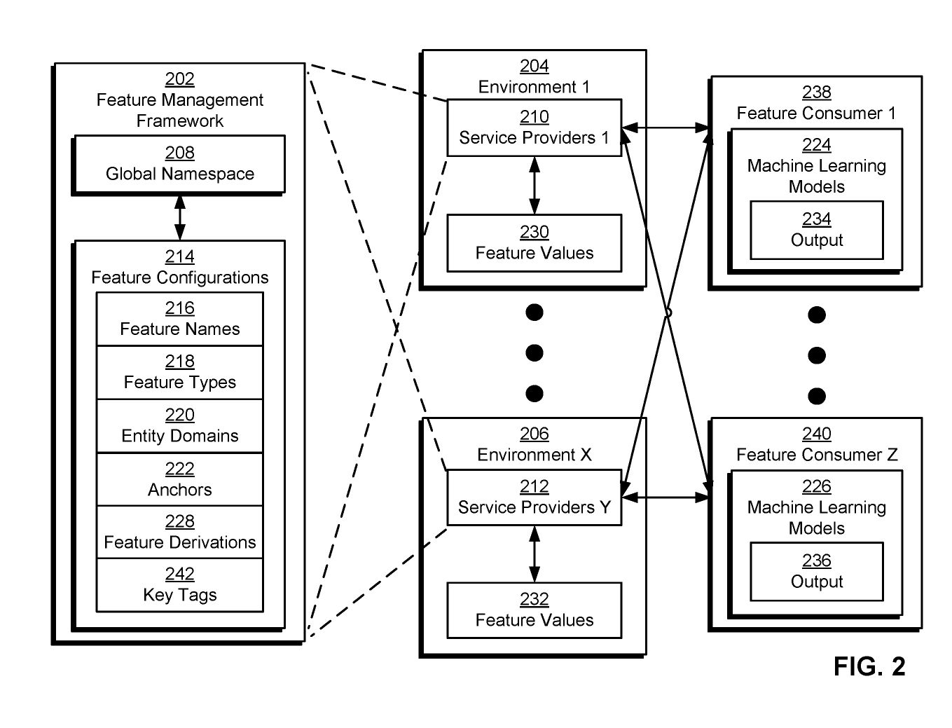

In one or more embodiments, data-processing system 102 includes functionality to perform centralized feature management in a way that is decoupled from environments, systems, and/or use cases of the features. As shown in FIG. 2, a system for processing data (e.g., data-processing system 102 of FIG. 1) includes a feature management framework 202 that executes in and/or is deployed across a number of service providers (e.g., service providers 1 210, service providers y 212) in different environments (e.g., environment 1 204, environment x 206).

The environments include different execution contexts and/or groups of hardware and/or software resources in which feature values 230-232 of the features can be obtained or calculated. For example, the environments may include an online environment that provides real-time feature values, a nearline or streaming environment that emits events containing near-realtime records of updated feature values, an offline environment that calculates feature values on a periodic and/or batch-processing basis, and/or a search-based environment that performs fast reads of databases and/or other data stores in response to queries for data in the data stores.

One or more environments may additionally be contained or nested in one or more other environments. For example, an online environment may include a “remix” environment that contains a library framework for executing one or more applications and/or generating additional features.

The service providers may include applications, processes, jobs, services, and/or modules for generating and/or retrieving feature values 230-232 for use by a number of feature consumers (e.g., feature consumer 1 238, feature consumer z 240). The feature consumers may use one or more sets of feature values 230-232 as input to one or more machine learning models 224-226 during training, testing, and/or validation of machine learning models 224-226 and/or scoring using machine learning models 224-226. In turn, output 234-236 generated by machine learning models 224-226 from the sets of feature values 230-232 may be used by the feature consumers and/or other components to adjust parameters and/or hyperparameters of machine-learning models 224-226; verify the performance of machine-learning models 224-226; select versions of machine-learning models 224-226 for use in production or real-world settings; and/or make inferences, recommendations, predictions, and/or estimates related to feature values 230-232 within the production or real-world settings.

In one or more embodiments, the service providers use components of feature management framework 202 to generate and/or retrieve feature values 230-232 of features from the environments in a way that is decoupled from the locations of the features and/or operations or computations used to generate or retrieve the corresponding feature values 230-232 within the environments. First, the service providers organize the features within a global namespace 208 that spans the environments. Global namespace 208 may include a hierarchical representation of feature names 216 and use scoping relationships in the hierarchical representation to disambiguate among features with common or similar names, as described in the above-referenced application. Consequently, global namespace 208 may replace references to locations of the features (e.g., filesystem paths, network locations, streams, tables, fields, services, etc.) with higher-level abstractions for identifying and accessing the features.

Second, the service providers use feature configurations 214 in feature management framework 202 to define, identify, locate, retrieve, and/or calculate features from the respective environments. Each feature configuration includes metadata and/or information related to one or more features in global namespace 208. Individual feature configurations 214 can be independently created and/or updated by a user, team, and/or entity without requiring knowledge of feature configurations 214 for other features and/or from other users, teams, and/or entities.

Feature configurations 214 include feature names 216, feature types 218, entity domains 220, anchors 222, feature derivations 228, and key tags 242 associated with the features. Feature names 216 include globally scoped identifiers for the features, as obtained from and/or maintained using global namespace 208. For example, a feature representing the title in a member's profile with a social network or online professional network may have a globally namespaced feature name of “org.member.profile.title.” The feature name may allow the feature to be distinguished from a different feature for a title in a job listing, which may have a globally namespaced feature name of “org.job.title.”

Feature types 218 include semantic types that describe how the features can be used with machine learning models 224-226. For example, each feature may be assigned a feature type that is numeric, binary, categorical, categorical set, categorical bag, and/or vector. The numeric type represents numeric values such as real numbers, integers, and/or natural numbers. The numeric type may be used with features such as numeric identifiers, metrics (e.g., page views, messages, login attempts, user sessions, click-through rates, conversion rates, spending amounts, etc.), statistics (e.g., mean, median, maximum, minimum, mode, percentile, etc.), scores (e.g., connection scores, reputation scores, propensity scores, etc.), and/or other types of numeric data or measurements.

The binary feature type includes Boolean values of 1 and 0 that indicate if a corresponding attribute is true or false. For example, binary features may specify a state of a member (e.g., active or inactive) and/or whether a condition has or has not been met.

Categorical, categorical set, and categorical bag feature types include fixed and/or limited names, labels, and/or other qualitative attributes. For example, a categorical feature may represent a single instance of a color (e.g., red, blue, yellow, green, etc.), a type of fruit (e.g., orange, apple, banana, etc.), a blood type (e.g., A, B, AB, O, etc.), and/or a breed of dog (e.g., collie, shepherd, terrier, etc.). A categorical set may include one or more unique values of a given categorical feature, such as {apple, banana, orange} for the types of fruit found in a given collection. A categorical bag may include counts of the values, such as {banana: 2, orange: 3} for a collection of five pieces of fruit and/or a bag of words from a sentence or text document.

The vector feature type represents an array of features, with each dimension or element of the array corresponding to a different feature. For example, a feature vector may include an array of metrics and/or scores for characterizing a member of a social network. In turn, a metric such as Euclidean distance or cosine similarity may be calculated from feature vectors of two members to measure the similarity, affinity, and/or compatibility of the members.

Entity domains 220 identify classes of entities described by the features. For example, entity domains 220 for features related to a social network or online professional network may include members, jobs, groups, companies, products, business units, advertising campaigns, and/or experiments. Entity domains 220 may be encoded and/or identified within global namespace 208 (e.g., “jobs.title” versus “member.title” for features related to professional titles) and/or specified separately from global namespace 208 (e.g., “feature1.entitydomain=members”). One or more features may additionally have compound entity domains 220. For example, an interaction feature between members and jobs may have an entity domain of {members, jobs}.

Anchors 222 include metadata that describes how to access the features in specific environments. For example, anchors 222 may include locations or paths of the features in the environments; classes, functions, methods, calls, and/or other mechanisms for accessing data related to the features; and/or formulas or operations for calculating and/or generating the features from the data.

A service provider may use an anchor for accessing a feature in the service provider's environment to retrieve and/or calculate one or more feature values (e.g., feature values 230-232) for the feature and provide the feature values to a feature consumer. For example, the service provider may receive, from a feature consumer, a request for obtaining feature values of one or more features from the service provider's environment. The service provider may match feature names in the request to one or more anchors 222 for the corresponding features and use the anchors and one or more entity keys (e.g., member keys, job keys, company keys, etc.) in the request to obtain feature values for the corresponding entities from the environment. The service provider may optionally format the feature values according to parameters in the request and return the feature values to the feature consumer for use in training, testing, validating, and/or executing machine learning models (e.g., machine learning models 224-226) associated with the feature consumer. Using anchors to access features in various environments is described in a co-pending non-provisional application filed on the same day as the instant application, by inventors David Stein, Paul Ogilvie, Bee-Chung Chen, Shaunak Chatterjee, Priyanka Gariba, Kevin Wu, Grace Tang, Yangchun Luo, Boyi Chen, Amit Yadav, Ruoyang Wang, Divya Gadde, Wenxuan Gao, Amit Chandak, Varnit Agnihotri, David Zhuang, Joel Young and Weidong Zhang, entitled “Framework for Managing Feature Across Environments,” having serial number TO BE ASSIGNED, and filing date TO BE ASSIGNED (Attorney Docket No. LI-902216-US-NP), which is incorporated herein by reference.

Feature derivations 228 include metadata for calculating or generating derived features (e.g., derived features 116 of FIG. 1) from other “input” features, such as primary features with anchors 222 in the respective environments and/or other derived features. For example, feature derivations 228 may include expressions, operations, and/or references to code for generating or calculating the derived features from other features. Like anchors 222, feature derivations 228 may identify features by globally namespaced feature names 216 and/or be associated with specific environments. For example, a feature derivation may specify one or more input features used to calculate a derived feature and/or one or more environments in which the input features can be accessed.

In one or more embodiments, a feature is “reachable” (i.e., available or accessible) in a given environment if the feature can be obtained using an anchor for that environment and/or generated from input features that are identified as reachable in that environment. Thus, an “anchored” feature (a feature with an anchor) is reachable when an anchor for the feature can be used to retrieve the feature from the environment. Similarly, a derived feature may inherit its reachability (or lack of reachability) from input features used to generate the feature in the environment.

When a derived feature is generated from input features that are reachable in more than one environment, a single feature derivation for generating the derived feature from the features can be used to define the derived feature and “add” the derived feature to all environments in which the input features are found. For example, a single feature derivation can be used to calculate a derived feature in online, offline, and streaming environments when all input features used in the feature derivation to generate the derived feature can be found in each environment.

Feature configurations 214 may additionally provide multiple paths for accessing a feature in an environment. For example, feature configurations 214 may include an anchor for obtaining a given feature in an environment, as well as a feature derivation for generating or calculating the feature from other features in the environment. As a result, the feature may be obtained using the anchor and/or by generating the feature from the other features. In another example, feature configurations 214 may include multiple feature derivations 228 for calculating a derived feature from different sets of input features. Thus, the feature may be calculated from any or all sets of features identified in the feature derivations.

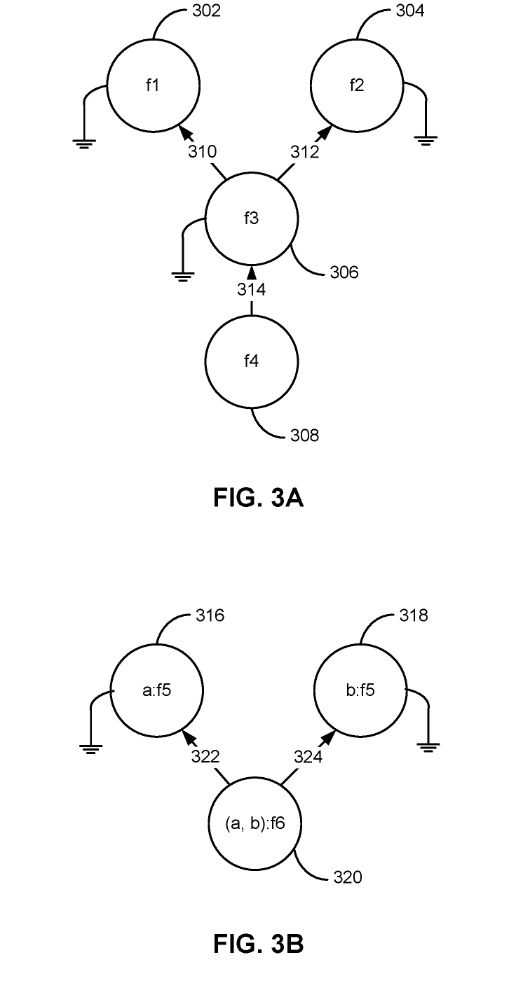

When a service provider receives a request containing a feature name for a derived feature, the service provider obtains one or more feature configurations 214 related to the derived feature in the service provider's environment. The service provider uses the obtained feature configurations 214 to identify one or more additional features used to generate the derived feature and generate a dependency graph of the features. The service provider then uses the dependency graph and/or feature configurations to derive an evaluation order associated with the features. For example, the service provider may generate the evaluation order so that features that are higher in the evaluation order are used to resolve dependencies of features that are lower in the evaluation order. In other words, the service provider may place a feature in the evaluation order after all of the feature's dependencies in the dependency graph. Dependency graphs for calculating derived features are described in further detail below with respect to FIGS. 3A-3B.

The service provider additionally verifies that the derived feature is reachable in the environment. For example, the service provider may use feature configurations 214 and/or feature derivations 228 to confirm that all dependencies of the derived feature either have anchors 222 in the environment or are derived from features that are reachable in the environment.

The service provider may further verify a compatibility of the derived feature with one or more input features used to generate the derived feature. For example, the service provider may compare feature types 218 of the derived feature and input features to ensure that the feature types are compatible with one another and/or operations applied to the features to generate the derived feature.

After the service provider verifies the reachability of the derived feature in the environment and the compatibility of the derived feature with its dependencies, the service provider obtains and/or calculates features in the dependency graph according to the determined evaluation order. For example, the service provider may use one or more anchors 222 to obtain feature values from the environment, use the obtained feature values to generate other feature values, and use existing feature values to generate further feature values until feature values of the derived feature have been produced. The service provider may then return feature values of the derived feature and/or other features included in the request in a response to the request.

An exemplary set of feature derivations for generating derived features may include the following representation:

```
derivations: {
  featureQ: “log(featureA)”
  featureR: “featureC + featureD”
}
```

In the above representation, a first derived feature named “featureQ” is derived from another feature named “featureA” using a function named “log.” A second derived feature named “featureR” is derived from two features named “featureC” and “featureD” using the “+” operator. As a result, the first derived feature may be calculated as the logarithm of “featureA,” and the second derived feature may be calculated from the sum and/or concatenation of “featureC” and “featureD.”

A service provider may use the feature derivations above to calculate values of “featureR” feature from “featureC” and “featureD” in the service provider's environment. First, the service provider may generate a dependency graph containing “featureR,” “featureC,” “featureD,” and any dependencies of “featureC” and “featureD.” The service provider may use the dependency graph to verify that all features in the dependency graph are reachable in the environment. The service provider may also use feature configurations 214 of the features to verify that feature types 218 of features in the dependency graph are compatible with dependencies of the features. For example, the service provider may verify that the feature type of “featureR” can be produced using feature types 218 of “featureC” and “featureD,” and that the “+” operator can be applied to feature types 218 of “featureC” and “featureD.” The service provider may then use anchors 222 and/or feature derivations 228 associated with the environment to obtain or generate feature values of “featureC” and “featureD,” apply the “+” operator to the feature values to produce feature values of “featureR,” and provide the “featureR” feature values in response to a request from a feature consumer and/or as part of a feature-processing workflow in the environment.

Key tags 242 represent entities associated with the features. For example, a key tag may optionally be included with and/or as part of a feature name to describe one or more entities associated with the querying, retrieval, and/or calculation of the corresponding feature. For example, a feature may be defined using “targetId:member_title,” with “targetId” representing a key tag for the feature and “member_title” representing the name of the feature. Thus, “targetId” may represent an entity key that is used to retrieve or calculate the “member_title” feature. In turn, a request for the feature may identify the feature using “member1:member_title,” with a value of a “member1” variable or field used as “targetId” in retrieving or generating a feature value of “member_title.”

In another example, a feature may be defined using “(viewerId, vieweeId):member_member_affinity_score.” In this example, “viewerId” and “vieweeId” are key tags for two separate entities involved in querying or producing the feature, and “member_member_affinity_score” represents the name of the feature. Thus, the feature may be an affinity feature that is defined over a compound entity domain represented by (members X members), with a first member used to produce the feature given as “viewerId” and a second member used to produce the feature given as “vieweeId.”

In a third example, a list of features used as input to a machine learning model may include the following exemplary representation:

[(viewerId):member_seniority, (vieweeId):member_seniority]

In the above representation, “viewerId” and “vieweeId” are used as key tags to identify two separate entities associated with the same feature of “member_seniority.” In turn, the key tags may be used to retrieve, for the two entities, two sets of feature values for the “member_seniority” feature.

In turn, the service providers use key tags 242 to specify and/or distinguish among multiple entities during retrieval of features from the corresponding environments and/or generation of derived features from other features. For example, a feature derivation for a derived feature may include the following representation:

```
dualkey_feature: {
  key: [mld, jld]
  inputs: {
  arg0: { key: mld, feature: member_numConnections }
  arg1: { key: jld, feature: job_popularityScore }
  }
  definition: “arg0 * arg1”
}
```

The above representation includes a feature name of “dualkey_feature” for the derived feature. The representation also specifies a set of two key tags 242 for the derived feature, which are represented using the names of “mld” and “jld.” The representation further identifies a set of “inputs” (i.e., input features) used to generate the derived feature. The first input feature is identified by “arg0” and is defined using the first key tag of “mld” and a feature name of “member_numConnections.” The second input feature is identified by “arg1” and is defined using the second key tag of “jld” and a feature name of “job_popularityScore.” Finally, the representation includes a “definition” of the derived feature, which specifies that the derived feature is to be calculated by applying the “*” operator to features represented by “arg0” and “arg1.” In other words, two key tags 242 associated with the derived feature may be used individually with two input features used to produce the derived feature, thus allowing the derived feature to be generated from input feature values of “member_numConnections” and “job_popularityScore” for two separate entities represented by “mld” and “jld.”

By using service providers in different environments to implement, provide, and/or use a uniform feature management framework 202 containing global namespace 208, feature configurations 214, anchors 222, feature derivations 228, and key tags 242, the system of FIG. 2 may reduce complexity and/or overhead associated with generating, managing, and/or retrieving features. In particular, the system may provide a common data model for feature derivations 228 and key tags 242 that allow the querying, retrieval, and/or generation of primary and/or derived features in various environments to be defined in a flexible and/or configuration-based manner In turn, the service providers may use feature derivations 228 and key tags 242 to validate feature types 218 and/or reachabilities of the features in the environments, identify and select options for obtaining the features in the environments, and/or use different entity keys and/or combinations of entity keys to obtain the features. Consequently, the system may provide technological improvements related to the development and use of computer systems, applications, services, and/or workflows for producing features, consuming features, and/or using features with machine learning models.

Those skilled in the art will appreciate that the system of FIG. 2 may be implemented in a variety of ways. First, feature management framework 202, the service providers, and/or the environments may be provided by a single physical machine, multiple computer systems, one or more virtual machines, a grid, one or more databases, one or more filesystems, and/or a cloud computing system. Moreover, various components of the system may be configured to execute in an offline, online, and/or nearline basis to perform different types of processing related to managing, accessing, and using features, feature values, and machine learning models 224-226.

Second, feature configurations 214, feature values, and/or other data used by the system may be stored, defined, and/or transmitted using a number of techniques. For example, the system may be configured to accept features from different types of repositories, including relational databases, graph databases, data warehouses, filesystems, streams, online data stores, and/or flat files. The system may also obtain and/or transmit feature configurations 214, feature values, and/or other data used by or with feature management framework 202 in a number of formats, including database records, property lists, Extensible Markup language (XML) documents, JavaScript Object Notation (JSON) objects, source or executable code, and/or other types of structured data. Each feature configuration may further encompass one or more features, anchors 222, feature derivations 228, service providers, and/or environments.

In another example, global namespace 208 and/or feature configurations 214 may be stored at individual service providers, in a centralized repository that is synchronized with and/or replicated to the service providers, and/or in a distributed ledger or store that is maintained and/or accessed by the service providers. Each service provider may further include or have access to all feature configurations 214 for all features across all environments, or each service provider may include or have access to a subset of feature configurations 214, such as feature configurations 214 for features that are retrieved or calculated by that service provider.

FIG. 3A shows an exemplary dependency graph for a set of features in accordance with the disclosed embodiments. The dependency graph of FIG. 3A includes a set of nodes 302-308 representing the features. Node 302 represents a feature named “f1,” node 304 represents a feature named “f2,” node 306 represents a feature named “f3,” and node 308 represents a feature named “f4.”

A set of directed edges 310-314 between pairs of nodes 302-308 represents dependencies associated with the corresponding features. For example, edge 310 indicates a dependency of “f3” on “f1,” edge 312 indicates a dependency of “f3” on “f2,” and edge 314 indicates a dependency of “f4” on “f3.” Thus, “f3” may be calculated or generated using values of “f1” and “f2,” and “f4” may be calculated or generated using values of “f3.” In turn, an evaluation order for the dependency graph may specify the generation and/or retrieval of “f1” and “f2” first, followed by the evaluation of “f3” using “f1” and “f2,” and finally ending with the evaluation of “f4” using “f3.”

Within the dependency graph, nodes 302-306 are shown as having anchors in one or more environments. As a result, feature “f3” may be obtained from an environment in which the feature is anchored, or “f3” may be calculated from “f1” and “f2” when anchors for “f1” and “f2” are available in a given environment. If an environment includes anchors for “f1,” “f2,” and “f3,” a service provider may choose to generate values of “f3” from values of “f1” and “f2” or use an anchor to obtain values of “f3.” The mechanism selected by the service provider to obtain values of “f3” may be based on the availability or recency of values of “f1,” “f2,” and “f3” in the environment; overhead or latency associated with retrieving values of “f3” compared with calculating values of “f3” from “f1” and “f2”; and/or other factors or considerations.

After values of “f3” are calculated or obtained, a feature derivation for “f4” may be used to generate values of “f4” from values of “f3.” For example, the feature derivation may apply one or more operations, functions, and/or expressions to values of “f3” to produce corresponding values of “f4.”

FIG. 3B shows an exemplary dependency graph for a set of features in accordance with the disclosed embodiments. The dependency graph of FIG. 3B includes three nodes 316-320 representing the features. Node 316 represents a feature identified using “a:f5,” node 318 represents a feature identified using “b:f5,” and node 320 represents a feature identified using “(a, b):f6.” Nodes 316-318 are shown as having anchors in one or more environments, and directed edges 322-324 between node 320 and nodes 316-318 indicate that “(a, b):f6” depends on “a:f5” and “b:f5.”

In the dependency graph of FIG. 3B, each feature is identified using a feature name and one or more key tags. Nodes 316-318 represent a feature named “f5,” which is associated with a key tag of “a” in node 316 and “b” in node 318. Node 320 represents a feature named “f6,” which is associated with both key tags of “a” and “b.” Consequently, the dependency graph of FIG. 3B indicates that “f6” is to be calculated or generated using two different values of “f5” associated with entities represented by “a” and “b.” In turn, an evaluation order for the dependency graph may specify the retrieval of two values of “f5” using entity keys matched to the “a” and “b” key tags, followed by the generation of “f6” using the two values of “f5.”

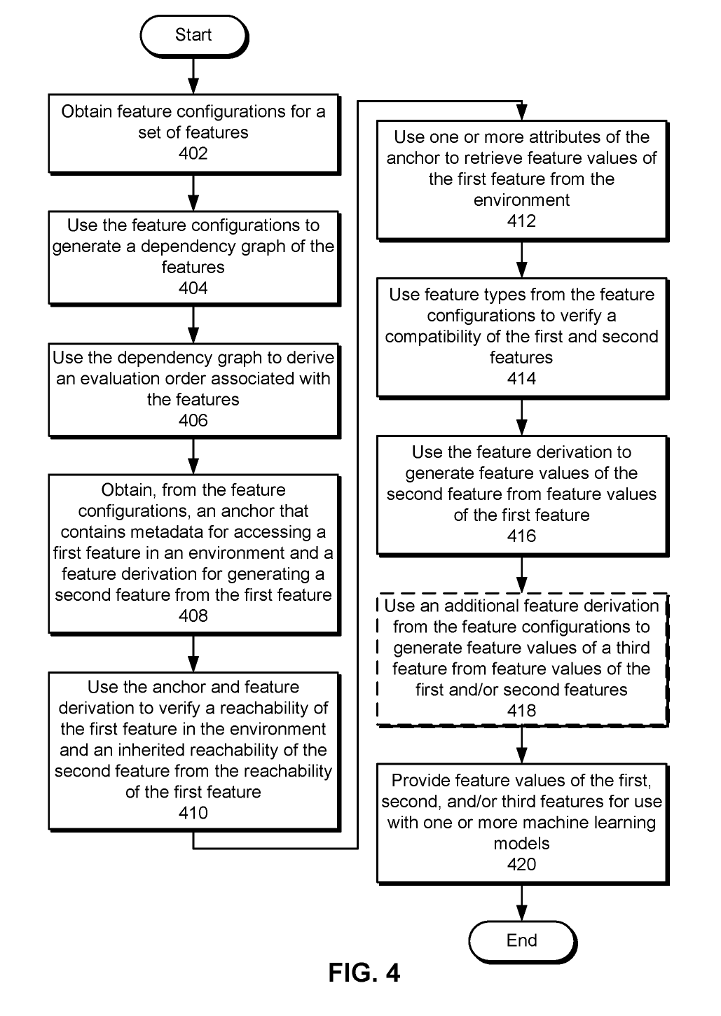

FIG. 4 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the technique.

Initially, feature configurations for a set of features are obtained (operation 402) and used to generate a dependency graph of the features (operation 404). For example, the feature configurations may include anchors and feature derivations for features in an environment. The dependency graph may thus represent dependencies of derived features on other features in the environment.

In turn, the dependency graph is used to derive an evaluation order associated with the features (operation 406). For example, the dependency graph may be used to generate an evaluation order that evaluates all dependencies of a derived feature before evaluating the derived feature.

Next, an anchor that contains metadata for accessing a first feature in an environment and a feature derivation for generating a second feature from the first feature are obtained from the feature configurations (operation 408). In other words, the first feature may represent a primary feature that is “anchored” in the environment, and the second feature may represent a derived feature that is calculated or produced from the first feature.

The anchor and feature derivation are also used to verify a reachability of the first feature in the environment and an inherited reachability of the second feature from the reachability of the first feature (operation 410). For example, the reachability of the first feature may be verified by ensuring that an anchor for retrieving the feature in the environment exists. In turn, the inherited reachability of the second feature may be verified by ensuring that a feature derivation for generating the second feature from the first feature exists for the same environment. One or more attributes of the anchor are then used to retrieve feature values of the feature from the environment (operation 412).

Feature types from the feature configurations are also used to verify a compatibility of the first and second features (operation 414). For example, the feature types of the first and second features may be compared to ensure that the second feature can be generated from the first feature and/or the feature types are compatible with operations applied to the first feature to produce the second feature.

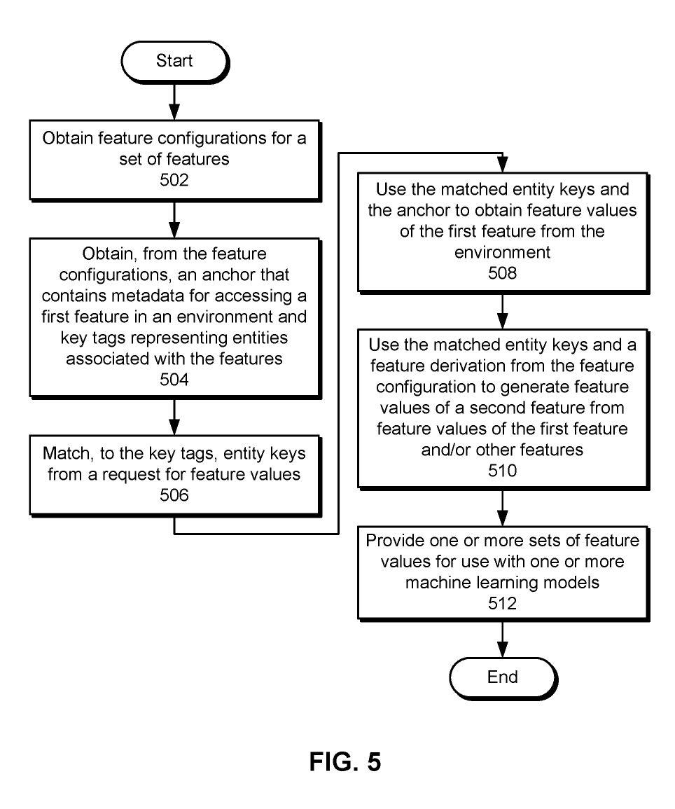

After the reachabilities and feature types of the feature are verified, the feature derivation is used to generate feature values of the second feature from feature values of the first feature (operation 416). For example, an operation, function, and/or expression from the feature derivation may be applied to feature values of the first feature to generate feature values of the second feature. The second feature may further be generated using key tags and/or entity keys associated with the first and second features, as described in further detail below with respect to FIG. 5.

An additional feature derivation from the feature configurations may optionally be used to generate feature values of a third feature from feature values of the first and/or second features (operation 418). As a result, the third feature may be a derived feature that is generated from the first, anchored feature and/or the second, derived feature.

Finally, feature values of the first, second, and/or third features are provided for use with one or more machine learning models (operation 420). For example, the feature values may be provided as input to a machine learning model, and a score may be obtained as output from the machine learning model. The score may then be used to generate recommendations, predictions, estimates, and/or other types of inference related to the feature and/or corresponding entity.

FIG. 5 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the technique.

First, feature configurations for a set of features are obtained (operation 502). Next, an anchor that contains metadata for accessing a first feature in an environment and key tags representing entities associated with the features are obtained from the feature configurations (operation 504). For example, the feature configurations may include feature names that are optionally associated with one or more key tags. The key tags may describe one or more entities involved in querying, retrieval, and/or generation of the corresponding features.

Entity keys from a request for feature values are then matched to the key tags (operation 506), and the matched entity keys and anchor are used to obtain feature values of the first feature from the environment (operation 508). For example, the request may include feature names of “member1:feature1” and “member2:feature1,” which indicate that two entity keys of “member1” and “member2” are used to obtain two separate values of a feature named “feature1” from the environment.

The matched entity keys and a feature derivation from the feature configuration are further used to generate feature values of a second feature from feature values of the first feature and/or other features (operation 510). Continuing with the previous example, the request may include a feature name of “(member1, member2):feature2,” and the feature derivation for “feature2” may specify calculating “feature2” from two values of “feature1” that are associated with different key tags. As a result, the value of “feature2” may be generated from both values of “feature1” from “member1” and “member2.”

In another example, the request may also, or instead, include feature names of “member3:feature3,” “member4:feature4” and “(member3, member4):feature2.” The feature derivation for “feature2” may additionally specify calculating “feature2” from a value of “feature3” associated with one key tag and a value of “feature4” associated with another key tag. Thus, the value of “feature2” may be calculated from values of “feature3” and “feature4” that are associated with different entity keys (e.g., two different members, two different jobs, a member and a job, a member and a company, a job and a company, etc.).

Finally, one or more sets of feature values are provided for use with one or more machine learning models (operation 512). For example, some or all feature values generated and/or retrieved in operations 508-510 may be returned in response to the request, and the returned feature values may be used to train, test, validate, and/or execute a machine learning model.

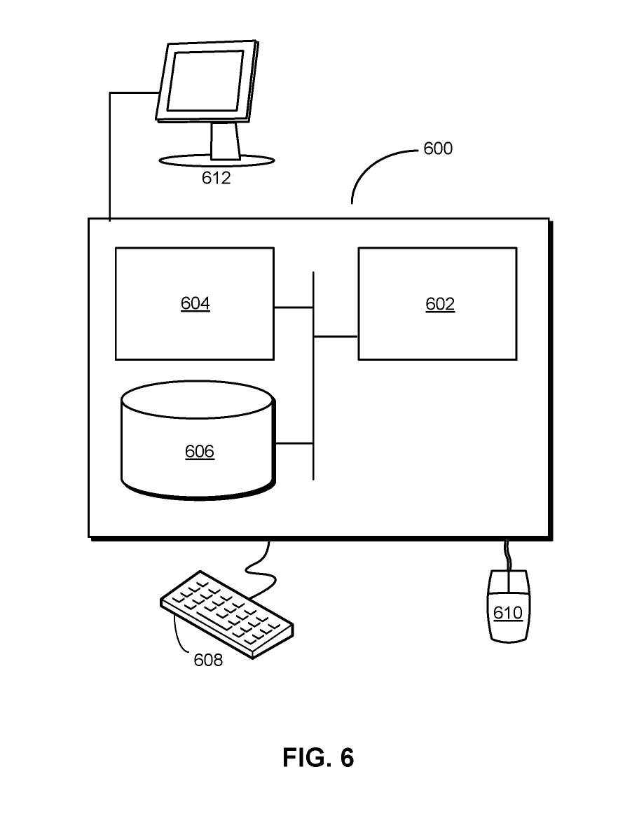

FIG. 6 shows a computer system 600 in accordance with the disclosed embodiments. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for processing data. The system includes a set of service providers executing in multiple environments, one or more of which may alternatively be termed or implemented as a module, mechanism, or other type of system component. Each service provider may obtain feature configurations for a set of features. Next, the service provider may obtain, from the feature configurations, an anchor containing metadata for accessing a first feature in an environment and a feature derivation for generating a second feature from the first feature. The service provider then uses one or more attributes of the anchor to retrieve feature values of the first feature from the environment. The service provider also uses the feature derivation to generate additional feature values of the second feature from the feature values of the first feature. Finally, the service provider provides the feature values of one or both features for use with one or more machine learning models.

The service provider may also, or instead, obtain key tags representing entities associated with the features from the feature configurations. Next, the service provider may matching, to the key tags, entity keys from a request for feature values. The service provider may then use the matched entity keys and the anchor to obtain feature values of the first feature from the environment and/or generate feature values of the second feature. Finally, the service provider may provide the feature values of one or both features for use with one or more machine learning models.

In addition, one or more components of computer system 600 may be remotely located and connected to the other components over a network. Portions of the present embodiments (e.g., service providers, environments, feature consumers, feature management framework, etc.) may also be located on different nodes of a distributed system that implements the embodiments. For example, the present embodiments may be implemented using a cloud computing system that manages, defines, generates, and/or retrieves features in a set of remote environments.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining feature configurations for a set of features;
obtaining, from the feature configurations:
an anchor comprising metadata for accessing a first feature in an environment; and
a feature derivation for generating a second feature from the first feature;
using one or more attributes of the anchor to retrieve, by one or more computer systems, one or more feature values of the first feature from the environment;
using the feature derivation to generate, by the one or more computer systems, one or more additional feature values of the second feature from the one or more feature values of the first feature; and
providing the one or more additional feature values for use with one or more machine learning models.

2. The method of claim 1, wherein using the feature derivation to generate the one or more additional feature values of the second feature comprises:
obtaining, from the feature derivation, key tags representing entities associated with the first and second features;
matching, to the key tags, entity keys associated with the first and second features from a request for feature values; and
using the matched entity keys to obtain the one or more feature values of the first feature and generate the one or more additional feature values of the second feature.

3. The method of claim 2, wherein using the matched entity keys to generate the one or more additional feature values of the second feature comprises:
using a first entity key for the first feature to obtain a first feature value of the first feature;
using a second entity key for the first feature to obtain a second feature value of the first feature; and
using the first and second feature values to generate a third feature value of the second feature.

4. The method of claim 1, further comprising:
prior to generating the one or more additional values of the second feature:
using the anchor to verify a reachability of the first feature in the environment; and
using the feature derivation to verify, based on the reachability of the first feature, an inherited reachability of the second feature in the environment.

5. The method of claim 1, further comprising:
obtaining, from the feature configurations, feature types for the first and second features; and
using the feature types and the feature derivation to verify a compatibility of the first and second features prior to generating the one or more additional feature values.

6. The method of claim 1, further comprising:
using the feature configurations to generate a dependency graph comprising the first and second features; and
using the dependency graph to derive an evaluation order associated with the first and second features.

7. The method of claim 1, further comprising:
obtaining, from the feature configurations, an additional feature derivation for generating a third feature from the second feature; and
using the additional feature derivation to generate a feature value of the third feature from the one or more additional feature values of the second feature.

8. The method of claim 1, further comprising:
obtaining, from the feature configurations, an additional anchor for a third feature and a feature derivation for generating the third feature from a fourth feature;
selecting a mechanism for obtaining the third feature from the additional anchor and the feature derivation; and
using the mechanism to obtain a feature value of the third feature.

9. The method of claim 1, wherein the feature derivation comprises at least one of:
an expression for generating the second feature from the first feature; and
code for calculating the second feature using the first feature.

10. The method of claim 1, wherein the environment is at least one of:
an online environment;
a nearline environment;
an offline environment;
a stream-processing environment; and
a search-based environment.

11. The method of claim 1, wherein the one or more computer systems execute in the environment.

12. A method, comprising:
obtaining feature configurations for a set of features;
obtaining, from the feature configurations:
an anchor comprising metadata for accessing a first feature in an environment; and
key tags representing entities associated with the set of features;
matching, to the key tags by one or more computer systems, entity keys from a request for feature values;
using the matched entity keys and the anchor to obtain, by the one or more computer systems, one or more feature values of the first feature from the environment; and
providing the one or more feature values for use with one or more machine learning models.

13. The method of claim 12, further comprising:
obtaining, from the feature configurations, a feature derivation for generating a second feature from the first feature; and
using the matched entity keys and the feature derivation to generate, by the one or more computer systems, one or more additional feature values of the second feature from the one or more feature values of the first feature.

14. The method of claim 13, wherein using the matched entity keys and the feature derivation to generate the one or more additional feature values of the second feature comprises:
using a first entity key for the first feature to obtain a first feature value of the first feature;
using a second entity key for the first feature to obtain a second feature value of the first feature; and
using a combination of the first and second entity keys for the second feature, the first feature value, and the second feature value to generate a third feature value of the second feature.

15. The method of claim 12, further comprising:
obtaining, from the feature configuration, a feature derivation for generating a second feature from a third feature and a fourth feature; and
matching, to the key tags, additional entity keys from an additional request; and
using the matched additional entity keys to generate one or more additional feature values of the second feature from feature values of the third and fourth features.

16. The method of claim 15, wherein using the matched additional entity keys and the feature derivation to generate the one or more additional feature values of the second feature comprises:
using a first entity key for the third feature to obtain a first feature value of the third feature;
using a second entity key for the fourth feature to obtain a second feature value of the fourth feature; and
using a combination of the first and second entity keys for the second feature, the first feature value, and the second feature value to generate a third feature value of the second feature.

17. The method of claim 12, further comprising:
using the feature configurations to generate a dependency graph comprising the first and second features; and
using the dependency graph to derive an evaluation order associated with the first and second features.

18. The method of claim 12, wherein the entity keys are associated with at least one of:
a member;
a company; and
a job.

19. A non-transitory computer-readable storage medium storing instructions that when executed by a computer cause the computer to perform a method, the method comprising:
obtaining feature configurations for a set of features;
obtaining, from the feature configurations:
an anchor comprising metadata for accessing a first feature in an environment; and
a feature derivation for generating a second feature from the first feature;
using one or more attributes of the anchor to retrieve one or more feature values of the first feature from the environment;
using the feature derivation to generate one or more additional feature values of the second feature from the one or more feature values of the first feature; and
providing the one or more additional feature values for use with one or more machine learning models.

20. The non-transitory computer-readable storage medium of claim 19, wherein using the feature derivation to generate the one or more additional feature values of the second feature comprises:
obtaining, from the feature derivation, key tags representing entities associated with the first and second features;
matching, to the key tags, entity keys associated with the first and second features from a request for feature values; and
using the matched entity keys to obtain the one or more feature values of the first feature and generate the one or more additional feature values of the second feature.
